(19) United States
(12) Patent Application Publication
(10) Pub. No.: US 2020/0202712 A1
(43) Pub. Date: Jun. 25, 2020

(54) Road condition prompt board for intelligent transportation

(71) Applicant: Yikai Chen, Binzhou City (CN)

(72) Inventor: Yikai Chen, Binzhou City (CN)

(21) Appl. No.: 16/805,830

(22) Filed: Mar. 1, 2020

(51) Int. Cl. G08G 1/09; G08G 1/07; G06K 9/00

(52) U.S. Cl. CPC G08G 1/094; G06K 9/00664; G08G 1/07

(57) ABSTRACT

The invention discloses an intelligent traffic road condition prompting board, which comprises a monitoring pillar. A rain shield is fixed on the left wall of the monitoring pillar. The monitoring pillar is provided with a reminder board power chamber. The reminder board power chamber is provided therein. There is a reminder board power device, which can provide power to the entire device. The invention has a simple structure, convenient maintenance, and convenient use. The invention can monitor the traffic situation of the road in real time and feedback it to the driver in the field. In addition, the driver can make a judgment in advance through the pre-travel time provided by the display device, so as to avoid congested roads in time, which not only reduces the traffic pressure on the road ahead, but also saves the driver's time, which greatly improves the traffic efficiency.

### CROSS-REFERENCES TO RELATED APPLICATIONS

The present application claims priority from Chinese application No. 2019111367498 filed on Sep. 19, 2019 which is hereby incorporated by reference in its entirety

### TECHNICAL FIELD

The invention relates to the field of intelligent transportation, and in particular relates to a road condition prompt board for intelligent transportation.

### BACKGROUND OF THE INVENTION

Nowadays, the roads in cities are getting more and more congested, and a large number of cars are driving on the roads, which often causes congestion on the roads. However, it has been a difficult problem to rectify the phenomenon of urban road congestion. From this, an intelligent transportation system has been developed. The intelligent transportation system is an effective and comprehensive application of advanced science and technology (information technology, computer technology, data communication technology, sensor technology, electronic control technology, automatic control theory, operations research, artificial intelligence, etc.) to transportation, service control, and Vehicle manufacturing, strengthen the connection between vehicles, roads, and users, so as to form a comprehensive transportation system that guarantees safety, improves efficiency, improves the environment, and saves energy. The installation of intelligent transportation devices can greatly reduce urban congestion. Therefore, this example has developed an intelligent traffic road prompt board.

### BRIEF SUMMARY OF THE INVENTION

Technical problems: Nowadays, the roads in cities are becoming more and more crowded. A large number of cars are driving on the roads, which often causes congestion on the road surface. However, it has been a difficult problem to rectify the congestion on urban roads.

In order to solve the above problems, an intelligent traffic road condition reminder board is designed in this example. The intelligent traffic road condition reminder board in this example includes a monitoring pillar, and a rain shield is fixed on the left wall of the monitoring pillar. The monitoring pillar There is a hinting board power cavity inside, there is a hinting board power device in the hinting board power cavity, the hinting board power device can provide power for the entire device, and a rotating drive shaft is provided at the upper end of the hinting board power cavity, A rotating first pulley is arranged in the prompting board power device, and the first pulley is fixed on the transmission shaft, so that the prompting board power device can transmit power to the transmission shaft;

A transmission cavity is provided in the right wall of the power chamber of the prompt board, and the right end of the transmission shaft extends into the transmission cavity. A camera rotation mechanism is provided in the transmission cavity, and a rotatable mechanism is provided in the camera rotation mechanism. A second pulley, the second pulley is fixed on the transmission shaft, so that the transmission shaft can transmit power to the camera rotating mechanism, and a rotatable camera rotates in the right wall of the transmission cavity A first connecting shaft that is rotatable in the camera rotating mechanism, and the left end of the camera rotating shaft is fixedly connected to the first connecting shaft, so that the camera rotating mechanism can drive the camera rotating shaft to rotate;

The camera rotation axis extends right out of the transmission cavity, and the right end of the transmission cavity is located symmetrically with two camera brackets on the camera rotation axis. The upper end of the camera bracket is fixedly connected to the monitoring pillar. A camera is fixed between the camera brackets and located on the camera rotation axis. The camera can shoot the road conditions in front. The right end of the camera is equipped with a flash. The upper end of the flash is fixed to the lower wall of the monitoring pillar. The flash has a flash function, so that the camera can shoot at night. A first wire is electrically connected to the upper end of the flash, and the right end of the first wire is electrically connected to the upper end of the camera. A second wire is electrically connected at the upper end and located at the left end of the first wire;

A camera control cavity is provided in the right wall of the transmission cavity, and the right end of the transmission shaft extends into the camera control cavity. A camera control mechanism is provided in the camera control cavity, and the camera control mechanism and the first The upper end of the wire is electrically connected, so that the camera control mechanism can control the start and stop of the camera and the flash. A central controller is fixed on the upper wall of the transmission cavity. The lower end of the central controller is connected to the second wire. The upper end is electrically connected, a third wire is electrically connected to the upper end of the central controller, and a warning light is electrically connected to the upper end of the third wire, so that the central controller can light the place through the third wire. The warning lamp further functions as a warning. A lightning rod is fixed on the top wall of the monitoring pillar to further protect against lightning. The central controller is electrically connected with a fourth wire, and the fourth wire has a right end. A display device is electrically connected, and the display device can display the estimated passing time, and then can prompt the driver so that the driver can bypass in advance.

Wherein, the prompt board power device includes a motor fixedly mounted on the lower wall of the power chamber of the prompt board, a power shaft is dynamically connected to the right end of the motor, and a third pulley is fixed on the power shaft. A first belt is connected to the third pulley, and an upper end of the first belt is rotatably connected to the first pulley.

Wherein, the camera rotating mechanism includes a first positioning shaft rotatably provided in the transmission cavity, a fourth pulley is fixed on the first positioning shaft, and a first pulley is connected to the fourth pulley. Two belts, the upper end of the second belt is connected with the second pulley, the first positioning shaft is provided with a hollow shaft that can slide left and right, and the hollow shaft and the first positioning shaft are connected by a spline, A magnetic block is fixed at the lower end of the hollow shaft, the magnetic block can slide left and right on the lower wall of the transmission cavity, an electromagnet spring is fixed at the left end of the magnetic block, and an electromagnet is fixed at the left end of the electromagnet spring. A second connecting shaft is fixed at the right end of the hollow shaft, and the right end of the second connecting shaft can be meshed with the first connecting shaft.

Wherein, the camera control mechanism includes a sector gear fixed to the right end of the transmission shaft, and a first bevel gear is symmetrically arranged up and down in the camera control cavity, and the sector gear can be aligned with the first cone arranged up and down. The gears are alternately meshed and connected. A second positioning shaft is fixed on the first bevel gear. The second positioning shaft is rotatably fixed on the upper and lower side walls of the transmission cavity. The right end of the first bevel gear is engaged. A second bevel gear is connected, a right end of the second bevel gear is fixed with a third positioning shaft, a right end of the third positioning shaft is fixed with a third bevel gear, and a right end of the third bevel gear is meshed with a first positioning gear. A four-bevel gear, the fourth bevel gear shaft is fixedly provided with a synchronous shaft, the synchronous shaft is fixedly provided with a first link, the first link is located at the front end of the fourth bevel gear, and the first connection A second link is provided at the right end of the lever, and the second link is hinged to the right end of the first link through a first positioning pin, and a center slider is hinged to the right end of the second link through a second positioning pin. A limit plate is provided at the lower end of the central slider, and the central slider can be The wall on the limit plate slides left and right, and a switch is fixed on the upper wall of the transmission cavity. The switch has a slidable switch slider. The right end of the central slider can be connected to the switch slider. A switch spring is elastically connected to the right end of the switch slider, and a metal contact is symmetrically arranged up and down in the switch. The metal contact can be connected to the switch slider in contact with the first contact. The wires are electrically connected.

The display device includes a hollow connecting rod symmetrically arranged on the left wall of the monitoring pillar, and a display screen is fixed at the left end of the hollow connecting rod. The display screen can display the travel time, and the display screen A right end is electrically connected to the fourth wire, a display screen support plate is fixed at the lower end of the display screen, and a right end of the display screen support plate is fixedly connected to the left wall of the monitoring pillar.

The beneficial effects of the invention are: the structure of the invention is simple, the maintenance is convenient, and the use is convenient. The invention can monitor the traffic situation of the road in real time and feedback it to the driver on the spot in real time, and the driver can provide the pre-travel time through the display device. It is possible to make a judgment in advance, so as to avoid congested roads in time, which not only reduces the traffic pressure on the road ahead, but also saves the driver's time, greatly improves the traffic efficiency, and is worthy of vigorous promotion.

### BRIEF DESCRIPTION OF THE DRAWINGS

For ease of explanation, the present invention is described in detail by the following specific embodiments and the accompanying drawings.

FIG. 1 is a schematic diagram of the overall structure of the present invention;

FIG. 2 is a schematic diagram of the “A-A” structure of FIG. 1; FIG.

FIG. 3 is a schematic diagram of the structure “B” of FIG. 1; FIG.

FIG. 4 is a schematic diagram of the “C” structure of FIG. 1.

### DETAILED DESCRIPTION OF THE INVENTION

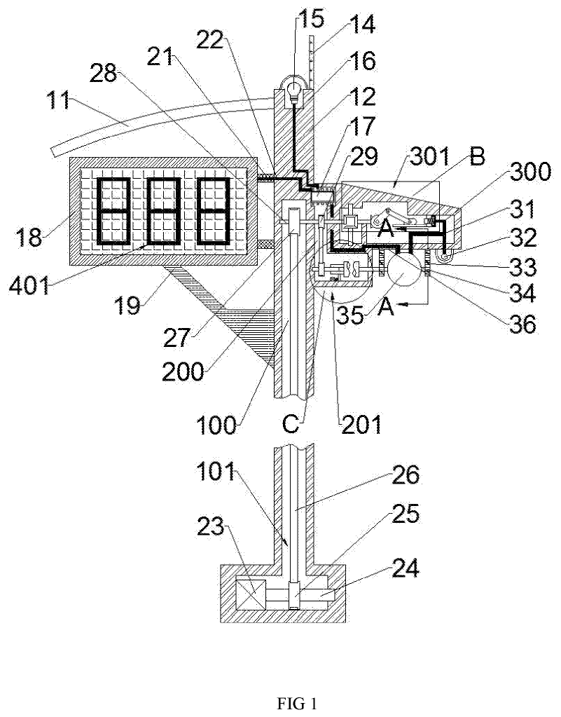

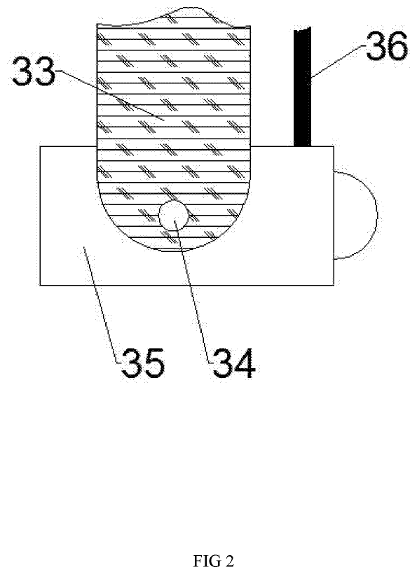

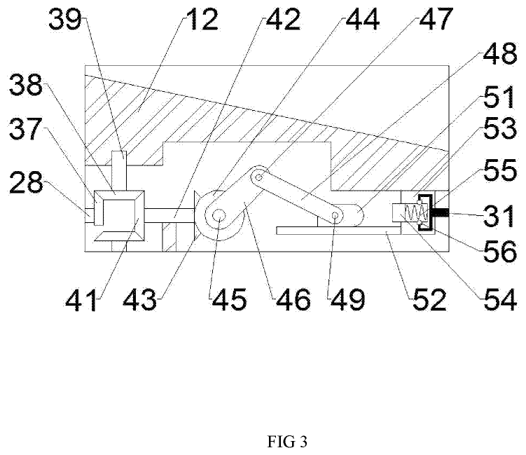

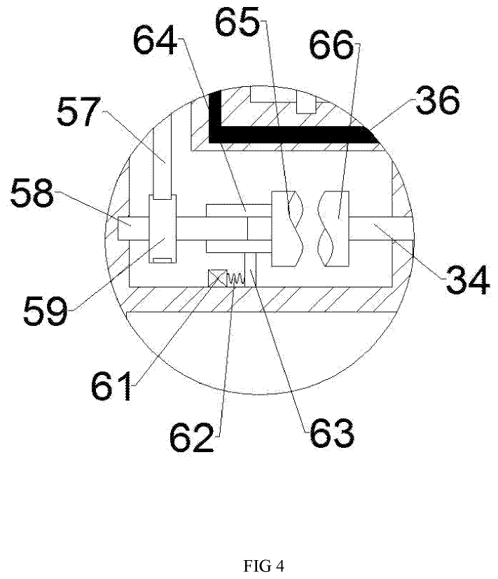

The present invention will be described in detail below with reference to FIGS. 1-4. For convenience of description, the orientation described below is defined as follows: the up-down, left-right, and front-back directions described below are consistent with the up-down, left-right, and front-back directions of the projection relationship of FIG.

The invention relates to an intelligent traffic road condition prompt board, which is mainly used in the field of intelligent traffic. The invention will be further described below with reference to the accompanying drawings of the invention:

The intelligent traffic road condition reminding board according to the present invention includes a monitoring pillar 12, a rain shield 11 is fixed on the left wall of the monitoring pillar 12, and a warning board power chamber 100 is provided in the monitoring pillar 12. A reminder board power device 101 is provided in the reminder board power chamber 100, which can provide power for the entire device. A rotating drive shaft 28 is provided at the upper end of the reminder board power chamber 100, and the reminder board power The device 101 is provided with a rotatable first pulley 27, and the first pulley 27 is fixed on the transmission shaft 28, and the prompting board power device 101 can transmit power to the transmission shaft 28. A transmission cavity 200 is provided in the right side wall of the reminder board power cavity 100, and the right end of the transmission shaft 28 extends into the transmission cavity 200. A camera rotation mechanism 201 is provided in the transmission cavity 200, and the camera rotation mechanism A second rotatable pulley 29 is provided in 201, and the second pulley 29 is fixed on the transmission shaft 28, and the transmission shaft 28 can transmit power to the camera rotation mechanism 201. A rotatable camera rotation axis is provided in the right wall of the transmission cavity 200 34. The camera rotation mechanism 201 is provided with a rotatable first connection shaft 66. The left end of the camera rotation shaft 34 is fixedly connected to the first connection shaft 66, and the camera rotation mechanism 201 can drive the camera. The rotating shaft 34 rotates, and the camera rotating shaft 34 extends out of the transmission cavity 200 to the right. The right end of the transmission cavity 200 and the camera rotating shaft 34 are symmetrically provided with two camera brackets 33. The camera bracket 33 The upper end is fixedly connected to the monitoring pillar 12, and a camera 35 is fixed between the camera brackets 33 and located on the camera rotation axis 34. The camera 35 can take pictures of the road conditions in the front, and the right end of the camera 35 is provided. There is a flash 32, and the upper end of the flash 32 is fixed to the lower wall of the monitoring pillar 12. The flash 32 has a flash function, so that the camera 35 can shoot at night. The upper end of the flash 32 is electrically connected to the device. There is a first electric wire 31, and the right end of the first electric wire 31 is electrically connected to the upper end of the camera 35, and the upper end of the camera 35 and the left end of the first electric wire 31 are electrically connected with a second The electric wire 36 is provided with a camera control cavity 300 in the right wall of the transmission cavity 200, and the right end of the transmission shaft 28 extends into the camera control cavity 300. The camera control cavity 300 is provided with a camera control mechanism 301. The camera control mechanism 301 is electrically connected to the upper end of the first electric wire 31, and then the camera control mechanism 301 can control the start and stop of the camera 35 and the flash 32, and a central part is fixed on the upper wall of the transmission cavity 200. A controller 17, a lower end of the central controller 17 is electrically connected to an upper end of the second wire 36, and a third wire 16 is electrically connected to an upper end of the central controller 17, and an upper end of the third wire 16 is electrically connected A warning light 15 is provided, and the central controller 17 can light the warning light 15 through the third electric wire 16 to play a warning role. A lightning rod 14 is fixed on the top wall of the monitoring pillar 12, and further Plays a lightning protection function. The central controller 17 is electrically connected with a fourth wire 22, and a right end of the fourth wire 22 is electrically connected with a display device 401. The display device 401 can display an estimated passing time. To the driver Give a hint so that the driver can detour ahead of time.

According to an embodiment, the cue board power device 101 is described in detail below. The cue board power device 101 includes a motor 23 fixed on the lower wall of the cue board power cavity 100, and the right end of the motor 23 is connected to a power device. There is a power shaft 24. A third pulley 25 is fixed on the power shaft 24. A first belt 26 is connected to the third pulley 25. The upper end of the first belt 26 is connected to the first pulley. 27 Turn the connection.

According to an embodiment, the camera rotation mechanism 201 is described in detail below. The camera rotation mechanism 201 includes a first positioning shaft 58 rotatably disposed in the transmission cavity 200, and the first positioning shaft 58 is fixed on the first positioning shaft 58. A fourth pulley 59 is provided. A second belt 57 is connected to the fourth pulley 59. An upper end of the second belt 57 is connected to the second pulley 29. The first positioning shaft 58 is provided. There is a hollow shaft 64 that can slide left and right. The hollow shaft 64 and the first positioning shaft 58 are connected by a spline. A magnetic block 63 is fixed at the lower end of the hollow shaft 64. The magnetic block 63 can be connected to the transmission. On the lower wall of the cavity 200, an electromagnet spring 62 is fixed on the left end of the magnetic block 63 left and right, an electromagnet 61 is fixed on the left end of the electromagnet spring 62, and a second connecting shaft 65 is fixed on the right end of the hollow shaft 64. The right end of the second connection shaft 65 can be meshed with the first connection shaft 66.

According to an embodiment, the camera control mechanism 301 will be described in detail below. The camera control mechanism 301 includes a sector gear 37 fixed to the right end of the transmission shaft 28. A bevel gear 38, the sector gear 37 can be alternately meshed with the first bevel gear 38 disposed above and below, the second bevel gear 38 is fixedly provided with a second positioning shaft 39, and the second positioning shaft 39 It is rotatably fixed in the upper and lower side walls of the transmission cavity 200. The right end of the first bevel gear 38 is meshed with a second bevel gear 41. The right end of the second bevel gear 41 is fixed with a third positioning shaft. 42. A third bevel gear 43 is fixed at the right end of the third positioning shaft 42. A fourth bevel gear 44 is meshed with the right end of the third bevel gear 43. The fourth bevel gear 44 is fixedly synchronized with the shaft center. A shaft 45, the synchronization shaft 45 is fixed with a first link 46, the first link 46 is located at the front end of the fourth bevel gear 44, and the second link 48 is provided at the right end of the first link 46, The second link 48 is hinged to the right end of the first link 46 through a first positioning pin 47. A central slider 51 is articulated at the right end of the two links 48 through a second positioning pin 49, and a limit plate 52 is provided at the lower end of the central slider 51. The central slider 51 can slide left and right on the upper wall surface of the limit plate 52 A switch 53 is fixed on the upper wall surface of the transmission cavity 200. A slidable switch slider 54 is provided in the switch 53. The right end of the central slider 51 can be connected to the switch slider 54 in a contact manner. A switch spring 55 is elastically connected to the right end of the slider 54, and a metal contact 56 is symmetrically provided in the switch 53. The metal contact 56 can be in contact with the switch slider 54. The metal contact 56 And is electrically connected to the first electric wire 31.

According to an embodiment, the display device 401 will be described in detail below. The display device 401 includes a hollow connecting rod 21 symmetrically arranged on the left wall of the monitoring pillar 12. The left end of the hollow connecting rod 21 is fixedly arranged. A display screen 18, on which a travel time can be displayed, a right end of the display screen 18 is electrically connected to the fourth wire 22, and a display support plate 19 is fixed at the lower end of the display screen 18, and the display The right end of the screen support plate 19 is fixedly connected to the left wall of the monitoring pillar 12.

The following describes in detail the use steps of an intelligent traffic road condition prompt board in this article with reference to FIGS. 1 to 4: In the initial state, the motor 23 is not running, the second connecting shaft 65 is separated from the first connecting shaft 66, and the electromagnet 61 No power, the camera 35 does not shoot, the flash 32 does not fire, the warning light 15 does not light, and no numbers are displayed on the display 18;

When the device is started, the motor 23 and the central controller 17 are started. The motor 23 drives the power shaft 24 to rotate. The power shaft 24 drives the transmission shaft 28 to rotate through the third pulley 25, the first belt 26, and the first pulley 27. 28 drives the sector gear 37 to rotate, and the sector gear 37 periodically meshes with the first bevel gear 38 symmetrically arranged up and down, and further drives the third positioning shaft 42 to periodically rotate forward and reverse through the second bevel gear 41, and the third positioning shaft 42 The third bevel gear 43 and the fourth bevel gear 44 drive the synchronous shaft 45 to rotate, and the synchronous shaft 45 drives the first link 46 to rotate. The first link 46 passes the first positioning pin 47, the second link 48, and the second positioning. The pin 49 drives the central slider 51 to periodically slide left and right, and then the central slider 51 periodically pushes the switch slider 54. The switch slider 54 and the metal contact 56 periodically contact each other, and the camera 35 and The flash 32 is turned on and off periodically, so that the camera 35 can periodically capture the traffic conditions on the road ahead, and transmit it to the central controller 17 through the second wire 36. The central controller 17 calculates the estimated transit time, and further by Four electric wire 22 to a display 18, such that the display 18 shows the estimated time of passing the road ahead, the driver for the reference;

When the front road is congested, the central controller 17 lights the warning light 15 through the third electric wire 16 so as to warn the driver;

When it is necessary to adjust the shooting angle, the electromagnet 61 is energized, so that the electromagnet 61 repels the magnetic block 63, the magnetic block 63 slides to the right, and the magnetic block 63 drives the second connecting shaft 65 to slide to the right through the hollow shaft 64, and further The second connecting shaft 65 is meshed with the first connecting shaft 66, and the transmission shaft 28 drives the first positioning shaft 58 to rotate through the second pulley 29, the second belt 57 and the fourth pulley 59, and the first positioning shaft 58 passes The hollow shaft 64, the second connection shaft 65, and the first connection shaft 66 drive the camera rotation shaft 34 to rotate, so that the angle of the camera 35 can be adjusted.

The beneficial effects of the invention are: the structure of the invention is simple, the maintenance is convenient, and the use is convenient. The invention can monitor the traffic situation of the road in real time and feedback it to the driver on the spot in real time, and the driver can provide the pre-travel time through the display device. It is possible to make a judgment in advance, so as to avoid congested roads in time, which not only reduces the traffic pressure on the road ahead, but also saves the driver's time, greatly improves the traffic efficiency, and is worthy of vigorous promotion.

The above are only specific embodiments of the invention, but the scope of protection of the invention is not limited to this. Any changes or replacements that are not thought through without creative work should be covered by the scope of protection of the invention. Therefore, the protection scope of the invention shall be subject to the protection scope defined by the claims.

1. A traffic condition prompt board for intelligent traffic, comprising a monitoring pillar, a rain shield is fixed on the left wall of the monitoring pillar, a monitoring board power chamber is provided in the monitoring pillar, and a prompt is provided in the power chamber of the warning board The power board of the reminder board can provide power for the entire device. The upper end of the power chamber of the reminder board is provided with a rotatable transmission shaft. The first power wheel of the reminder board is provided with a rotatable first pulley. The first pulley is fixed on the transmission shaft, so that the prompting board power device can transmit power to the transmission shaft;
A transmission cavity is provided in the right wall of the power chamber of the prompt board, and the right end of the transmission shaft extends into the transmission cavity. A camera rotation mechanism is provided in the transmission cavity, and a rotatable mechanism is provided in the camera rotation mechanism. A second pulley, the second pulley is fixed on the transmission shaft, so that the transmission shaft can transmit power to the camera rotating mechanism, and a rotatable camera rotates in the right wall of the transmission cavity A first connecting shaft that is rotatable in the camera rotating mechanism, and the left end of the camera rotating shaft is fixedly connected to the first connecting shaft, so that the camera rotating mechanism can drive the camera rotating shaft to rotate;
The camera rotation axis extends right out of the transmission cavity, and the right end of the transmission cavity is located symmetrically with two camera brackets on the camera rotation axis. The upper end of the camera bracket is fixedly connected to the monitoring pillar. A camera is fixed between the camera brackets and located on the camera rotation axis. The camera can shoot the road conditions in front. The right end of the camera is equipped with a flash. The upper end of the flash is fixed to the lower wall of the monitoring pillar. The flash has a flash function, so that the camera can shoot at night. A first wire is electrically connected to the upper end of the flash, and the right end of the first wire is electrically connected to the upper end of the camera. A second wire is electrically connected at the upper end and located at the left end of the first wire;
A camera control cavity is provided in the right wall of the transmission cavity, and the right end of the transmission shaft extends into the camera control cavity. A camera control mechanism is provided in the camera control cavity, and the camera control mechanism and the first The upper end of the wire is electrically connected, so that the camera control mechanism can control the start and stop of the camera and the flash. A central controller is fixed on the upper wall of the transmission cavity. The lower end of the central controller is connected to the second wire. The upper end is electrically connected, a third wire is electrically connected to the upper end of the central controller, and a warning light is electrically connected to the upper end of the third wire, so that the central controller can light the place through the third wire. The warning lamp further functions as a warning. A lightning rod is fixed on the top wall of the monitoring pillar to further protect against lightning. The central controller is electrically connected with a fourth wire, and the fourth wire has a right end. A display device is electrically connected, and the display device can display the estimated passing time, and then can prompt the driver so that the driver can bypass in advance.

2. The intelligent traffic road prompt board according to claim 1, wherein the prompt board power device comprises a motor fixed on the lower wall of the power chamber of the prompt board, and a power connection device at the right end of the motor is provided. There is a power shaft, a third pulley is fixed on the power shaft, a first belt is connected to the third pulley, and an upper end of the first belt is rotatably connected to the first pulley.

3. The intelligent traffic road condition prompting board according to claim 1, wherein the camera rotation mechanism comprises a first positioning shaft rotatably provided in the transmission cavity, and the first positioning shaft A fourth pulley is fixedly installed, a second belt is connected to the fourth pulley, an upper end of the second belt is connected to the second pulley, and the first positioning shaft is provided with a slidable left and right A hollow shaft, the hollow shaft is splined to the first positioning shaft, a magnetic block is fixed at the lower end of the hollow shaft, and the magnetic block can slide the left end of the magnetic block left and right on the lower wall of the transmission cavity An electromagnet spring is fixed, an electromagnet is fixed at the left end of the electromagnet spring, a second connecting shaft is fixed at the right end of the hollow shaft, and the right end of the second connecting shaft can be meshed with the first connecting shaft.

4. The intelligent traffic road condition prompting board according to claim 1, wherein the camera control mechanism includes a sector gear fixed to the right end of the transmission shaft, and the camera control cavity is symmetrically arranged up and down. A first bevel gear, the sector gear can be alternately meshed with the first bevel gear provided above and below, a second positioning shaft is fixed on the first bevel gear, and the second positioning shaft is rotatably fixed. In the upper and lower side walls of the transmission cavity, a right side end of the first bevel gear is meshed with a second bevel gear, a right end of the second bevel gear is fixed with a third positioning shaft, and a right end of the third positioning shaft is fixed. A third bevel gear is provided. A right side end of the third bevel gear is meshed with a fourth bevel gear. The fourth bevel gear is fixedly provided with a synchronous shaft at its center. The synchronous shaft is fixed with a first link. The first link is located at the front end of the fourth bevel gear. A second link is provided at the right end of the first link. The second link is hinged to the right end of the first link through a first positioning pin. The right end of the second link is hinged with a center slide through a second positioning pin. A limit plate is provided at the lower end of the central slider, the central slider can slide left and right on the wall surface of the limit plate, a switch is fixed on the upper wall surface of the transmission cavity, and a slideable switch is provided in the switch. A slider, the right end of the central slider can be contacted with the switch slider, a switch spring is elastically connected to the right end of the switch slider, and a metal contact is provided symmetrically in the switch, and the metal contact It can be in contact with the switch slider, and the metal contact is electrically connected with the first wire.

5. The intelligent traffic road condition prompting board according to claim 1, wherein the display device comprises a hollow connecting rod symmetrically arranged on the left wall of the monitoring pillar, and the left end of the hollow connecting rod is fixed on the left side. A display screen is provided, and the passing time can be displayed on the display screen. The right end of the display screen is electrically connected to the fourth wire. A display support plate is fixed at the lower end of the display screen, and the right end of the display support plate is fixed. It is fixedly connected with the left wall of the monitoring pillar.
